(19) United States
(12) Patent Application Publication
(10) Pub. No.: US 2011/0173452 A1
(43) Pub. Date: Jul. 14, 2011

(54) METHOD OF GENERATING COMPOUND TYPE COMBINED PUBLIC KEY

(76) Inventors: Xiang-hao Nan, Beijing (CN); Huaping Chen, Beijing (CN)

(21) Appl. No.: 12/995,097

(22) PCT Filed: May 27, 2009
(86) PCT No.: PCT/CN2009/000599

§ 371 Date: Mar. 4, 2011

(30) Foreign Application Priority Data
May 28, 2008 (CN) 200810113495.3

(51) Int. Cl. H04L 9/32; H04L 9/30; H04L 9/08

(52) U.S. Cl. 713/179; 380/45; 380/279

(57) ABSTRACT

The present invention constructs a compound type combined public key system on the basis of a combined public key CPK system. The combined key is combined by an identity key and a randomly defined key. The randomly defined key can be defined by a center, called a system key; and can be self-defined, called updating key. Combination of the identity key and the system key generates a first-order combined key. The first-order combined key is then combined with the updating key to generate a second-order combined key. The first-order combined key can be used for centralized digital signature and key exchange. The second-order combined key can be used for distributed digital signature, to provide individual with convenient key exchange and absolute privacy. A combining matrix, as a trust root, provides proof of integrity of identity and key, with no need of third party proof. The present invention can be widely used in fields such as trusted connecting (communication), code authentication (software), e-bank (note), trusted transaction, trusted logistics, and network management.

### FIELD OF INVENTION

This invention relates to crypto-system and identity authentication field. In particular, it relates to a CPK-based compound type combined public key generating method.

### BACKGROUND OF THE INVENTION

Information security mainly relates to authentication technology and data security. Authentication technology mainly relies on authentication protocol and digital signature algorithm. Data security relies on key exchange protocol.

One kind of digital signature requires that the signature key is defined by individual to ensure privacy and exclusiveness, so that no one else can have the same signature key, including the key management center. Key exchange requires to be uniformly defined by the key management center, to realize no-handshaking key exchange as much as possible, so as to fit for network grouping communication of storage and forwarding, and the nation can interfere if necessary.

Thus, internationally the common practice is that key exchange is uniformly defined by the key management center, and digital signature is defined by the user himself. Since all of the previous algorithms have the key structures composed of single factor, it is either centralized definition by the center or distributed definition by individuals, with no possibility of compatibility of different definition ways.

Digital signature protocol provides responsibility service, while key exchange provides privacy service. In modern authentication theory, key exchange also acts as one condition for subject authenticity proof: if A encrypts, whether B can decrypt. Digital signature protocol and key exchange protocol shall satisfy both scalability and immediacy. The scale of identity authentication and key exchange must be tremendous, and authentication and exchange must be direct, not depending on any external equipment's support. Thus, how to obtain the public key of the other party becomes the main task of modern cryptography research. In order to seek a protocol that satisfies scalability and immediacy, the scientific circle generally experiences the following developments:

In 1976, Diffie and Hellman proposed random number based D-H key exchange protocol, which becomes the basis of all of the modern key exchange protocols. D-H protocol is implemented by centrally defined system parameter T=(g, p), and only achieves two-way handshaking exchange but not one-way direct exchange.

In 1984, Shamir proposed IBC algorithm, which is centrally defined single factor mechanism that the key management center is responsible to generate. This achieves identity-based digital signature key, but cannot achieve privacy and exclusivity of the private key, and cannot achieve identity-based key exchange.

In 1996, PKI is proposed that belongs to self-defined single factor mechanism. Digital signature satisfied the requirement of self-definition. Under the condition of third party proof, it can be used for identity authentication. However, the key exchange must rely on LDAP, and thus cannot realize immediacy of the exchange.

In 2001, Dan Boneh and Matthew Franklin of the United States adopted Weil's pairing theory to build identity-based IBE encryption, which however cannot implement digital signature. Key exchange uses online running key management center to replace the CA of PKI.

Identity-based cryptosystem is the most promising technology that solves the cyberspace authentication puzzle, and has attracted extensive attention in recent years. Identity-based combined public key cryptosystem is a vital member of identity-based cryptosystem family. Combined Public Key (i.e., CPK) algorithm was proposed in 2003, and was formally published in Chinese Patent no. 200510002156.4 entitled “Identity-based key generating method” in 2005. CPK identity-based digital signature protocol and key exchange protocol satisfy scalability of proof and immediacy of verification, truly implement Shamir' vision, open up a new way to solve the scalability through combination, and transfer the complicated mapping problem from boundless identity-space onto boundless public-key-space to a simple issue of mapping from bounded identity-space onto a bounded public key space.

If an algorithm can satisfy the scalability of proof and the immediacy of verification, it would realize the trustworthy logic of “in advance” proof. That is, it does not start from the assumption that the subject is trustworthy, rather it directly proves the authenticity of the subject.

However, up until now, all of the proposed crypto-systems are single factor mechanisms, in which the keys are all defined by the system, such as IBC (identity-based public key) mechanism, IBE (identity-based encryption) mechanism, and CPK (Identity-based combined public key) under centralized management mode; or the keys are all defined by individuals, such as PKI (third-party-based public key) mechanism, PGP, PEM, etc. under distributed management mode. Since all belong to single factor mechanisms, a mechanism that allows individual to define the private key under centralized management mode cannot be implemented.

There are problems with the previous combined public key systems, further including:

1) The combined private key is a linear sum of the combined matrix keys, having the possibility to be collusion attacked.

2) The entity private key is generated by the management center, so that the entity does not have absolute exclusivity or privacy to the private key.

Thus, it is always a puzzle whether a system that allows the users to self-define keys can be established under centralized mode. This becomes an issue that needs to be solved.

### SUMMARY OF THE INVENTION

To solve the above problems, the present invention constructs a compound type combined public key system based on the existing combined public key CPK system. The combined key is combined by an identity key and a randomly defined key. The randomly defined key can be uniformly defined by center (called system key), and can be self-defined by individuals (called updating key). The identity key combines with the system key to define first-order compound key. The first-order compound key is then combined with the updating key to define second-order compound key.

The compound type combined public key system keeps all the properties and advantages of the original combined public key: the combined matrix for generating identity key is defined by the key management center. The definition of the combined matrix determines the nature of centralized management of this system. The combined matrix implements mapping from identity to key variable, to become “trust root” of the system. Identity-based algorithm system provides integrity proof of the entity identity and the key variable, with no need of proof from third party CA, and with no need of online support of a bulky directory database LDAP, so that there is no need of system dynamic maintenance. The random factor is defined by individuals, which ensures privacy and exclusivity of the signature key. However, since it is a system that individuals define the keys, support of certificate revocation list CRL is needed.

According to the present invention, the compound type combined public key system is constructed of identity key defined by combined matrix, the system key uniformly defined by the system, and the updating key self-defined by the user. For example:

Combined Key=identity key+system key(+updating key);

According to the present invention, in the compound type combined public key system, the combined matrix is defined by the key management center, and the public key combined matrix is published as the trust root, providing to each entity for calculating identity keys. The calculation procedure of the identity key provides integrity proof for the identity and the public key variable. Thus, the digital signature and key exchange do not need proof from a third party.

According to the present invention, a method of generating a compound type combined public key is provided, including the following steps: a key management center generating an identity private key (isk) of an entity based on the entity identity and combined matrix; combining the system private key (ssk) uniformly defined by the system and the identity private key (isk) to generate a first-order combined private key (csk′), writing the first-order combined private key (csk′) into an ID certificate, distributing to users; and allowing individual entities to self-define updating private key (usk), to have a second combination with the first-order combined private key to generate a second-order combined private key (csk″).

According to a preferred embodiment of the present invention, when the key needs to be changed, each entity can self-update the updating key pair (usk, UPK).

According to a preferred embodiment of the present invention, when signing, the second-order combined private key (csk″) is used to sign, and the accompany public key (APK) is sent to the relying party as a part of the signature code. For instance: SIG_{csk″}(TAG)=sign, APK.

Wherein the accompany public key APK is combined by the system public key and the updating public key: APK=SPK+UPK, SIG is the signature protocol, csk″ is the second-order combined private key used by the signature, TAG is the international standard defined entity identity domain, time domain and specified string, sign is the signature code, and APK is the random public key.

According to a preferred embodiment of the present invention, the relying party uses the combined public key matrix to calculate the identity public key (IPK), uses the random public key (APK) sent by the signing party to calculate the second-order combined public key (CPK″) of the other party, and verifies authenticity of the signature. For example:

Second-order Combined Public Key (CPK″)=Identity Public Key (IPK)+Accompany Public Key (APK);

SIG⁻¹_{CPK}(TAG)=sign′.

Wherein, SIG⁻¹ is the verification protocol, CPK″ is the second-order combined public key used for verification, TAG is the international standard defined entity identity domain, time domain and specified string, and sign′ is the verification code.

According to the present invention, in the compound type combined public key, joining of the random key brings great changes to the original combined public key CPK system:

1) The compound type combined public key mechanism breaks the restriction of the single factor public key mechanism, creates a multifactor public key compound mechanism, and widens the development of the public key mechanism.

2) The second-order compound mechanism from the first-order combined key and the updating key creates a new mechanism that allows the entity to self-define the updating key under the centralized management mode.

3) The “encryption” effect of the random private key to the identity private key covers exposure of the linear rule existed in the identity private key, so as to obtain reliable safeguard.

4) The system key and updating key in the compound system is exclusive for the entity, and the management center cannot control. This satisfies the requirement of privacy of the signature private key and the requirement of changing the key at anytime, without the need of system maintenance.

Other advantages, objectives, and features of the present invention will be described in the following description, and to some extent will become apparent to people skilled in the art based on the below teaching, or can be taught by implementing the present invention. The objectives and other advantages of the present invention can be implemented and obtained from the following specification, claims, and the structures shown in the figures.

### BRIEF DESCRIPTION OF THE DRAWINGS

In order to clarify the objectives, technical solutions, and advantages of the present invention, detailed description will be made in connection with the accompanying drawings, wherein:

FIG. 1 shows a basic structure of CPK system according to the present invention;

FIG. 2 shows a specific block diagram of CPK system shown in FIG. 1;

FIG. 3 shows a schematic view of ID certificate generation according to the present invention;

FIG. 4 shows a flowchart of CPK digital signature according to the present invention;

FIG. 5 shows an example of a big amount bill according to the present invention;

FIG. 6A shows a tag signature module according to the present invention;

FIG. 6B shows a tag verification module according to the present invention;

FIG. 7A shows a workflow of the electronic tag generation according to the present invention; and

FIG. 7B shows a workflow of the electronic tag verification according to FIG. 2 of the present invention.

### DETAILED DESCRIPTION OF THE PREFERRED EMBODIMENT

Digital signature is the main means of authentication. In the authentication system, identity authentication is the core of authentication. Detailed description will be made to embodiments of identity authentication system according to the present invention in connection with the accompanying drawings, from the aspects of algorithm, protocol and interface, etc. It is noted that the embodiments of the compound type combined public key technology and identity authentication system according to the present invention are examples only, and the present invention is not limited to the embodiments disclosed.

I. Compound Type Combined Public Key System

Compound type combined public key system is implemented on the basis of the combined public key (CPK). See CN application no. 200510002156.4 entitled “Identity-based key generating method”, the entire contents of which are incorporated herein by reference.

CPK refers to Combined Public Key. Compound type combined public key system is constructed on the basis of the combined public key, keeps all the advantages of the combined public key, and overcomes the deficiencies of collusion threat and private key unable to make self-definition.

In the compound type combined public key system, the key is divided into Identity-key, System-key and Updating-key.

The identity key is generated from identity of the entity, combined by using HASH value of the identity as the coordinate and selecting variable of combining matrix. The combining matrix of public/private key is defined by the key management center (KMC), and the public key combining matrix is published.

The system key is uniformly defined by the system, and is combined with the identity-key to generate a first-order combined key. Updating-key is self-defined by individual, and is combined with the first-order combined key to generate a second-order combined key.

(I) Principle of Generating Compound Type Combined Public Key

1. Elliptic Curve Key Compound Theorem

The combined public key system belongs to elliptic curve cryptography on finite field P, defined by (a, b, n, p). Wherein, a and b define a cubic equation: y²≡(x³+ax+b) mod p, G is a basic point of an additive group, and n is the order of the group using G as the basic point.

ECC key compound theorem follows:

In the elliptic curve cryptography ECC, among any number of public key/private key pairs, the sum of the private keys and the sum of the public keys constitute a new public key/private key pair.

If, the sum of the private keys is: (r₁+r₂+ . . . +rₘ) mod n=r,

The corresponding sum of the public keys is: R₁+R₂+ . . . +Rₘ=R (point add),

In that case, r and R happen to form a new public key/private key pair.

This is because R=R₁+R₂+ . . . Rₘ=r₁G+r₂G+ . . . rₘG=(r₁+r₂+ . . . +rₘ)ₙG=rG

(II) Generation of Identity Key

1) Construction of Combining Matrix

The combining matrix is divided into private key matrix and public key matrix. The size of both matrices is 32×32. The private key matrix is composed of random numbers that are different from each other and less than n. The elements in the matrix is represented as rᵢⱼ, and the private key matrix is represented as skm;

$$skm = ( \begin{matrix}{r}_{1 , 1} & {r}_{1 , 2} & ⋯ & {r}_{1 , 32} \\ {r}_{2 , 1} & {r}_{2 , 2} & ⋯ & {r}_{2 , 32} \\ & ⋯ & ⋯ & \\ {r}_{32 , 1} & {r}_{32 , 2} & ⋯ & {r}_{32 , 32}\end{matrix} )$$

The public key matrix is derived from the private key matrix, i.e., r_{i,j}G=(x_{i,j}, y_{i,j})=R_{i,j}. The public key matrix is represented as PKM

$$PKM = ( \begin{matrix}{R}_{1 , 1} & {R}_{1 , 2} & ⋯ & {R}_{1 , 32} \\ {R}_{2 , 1} & {R}_{2 , 2} & ⋯ & {R}_{2 , 32} \\ & ⋯ & ⋯ & \\ {R}_{32 , 1} & {R}_{32 , 2} & ⋯ & {R}_{32 , 32}\end{matrix} )$$

The Key management center defines the combining matrix, using the public key matrix as the trust root for publication, to provide to individual entity for calculating the matrix identity public key.

Since CPK combining algorithm is identity-based algorithm, calculation process of the identity public key provides proof of integrity of the identity and the public key variable, so that the digital signature and verification do not rely on a third party.

(2) Mapping from Identity to Matrix Coordinates

Mapping from identity to combining matrix coordinates is accomplished through HASH transformation of the identity. HASH output is adjusted to a mapping sequence YS having a length of 165 bits, with every 5 bits constituting a string w₀, w₁, . . . , w₃₂, to determine column coordinates and row coordinates.

YS=HASH(ID)=w₀,w₁,w₂ . . . , w₃₂; (w₃₃,-w₃₇)

The content U of W₀ indicates the origin coordinate of the column, and the following column coordinate is achieved by adding 1 to its former column coordinate.

w₁-w₃₂ indicate the row coordinates in turn.

(3) Combining Calculation of Identity Key

Calculation of identity-key (isk) is conducted in KMC. Assuming the ith row coordinate is represented by wᵢ, the column coordinate is represented as (u+i) mod 32, and the identity private key is isk, then the private key calculation is implemented by multiple addition on the finite field Fn:

$$isk = {\sum }_{i = 1}^{32} r [ {w}_{i} , {( u + i )}_{32} ] mod n$$

The public key calculation is implemented by point multiplication addition on the elliptic curve Ep(a,b):

$$IPK = {\sum }_{i = 1}^{32} R [ {w}_{i} , {( u + i )}_{32} ]$$

$$( point - add )$$

Combination of Keys

The identity key is combined with the system key to generate a first-order combined key, and then the first-order combined key is combined with the updating-key to generate a second-order combined key.

1) First-Order Combination of Identity-Key and System-Key

The key management center generates a system-key for each entity: ssk, SPK;

The first-order combined private key cpk′ is a combination of the identity private key and the system private key:

csk′=(isk+ssk)mod

The first-order combined private key csk′ is written into the ID certificate to be distributed to the users, and the system-private key ssk is deleted.

The first-order combined public key is a combination of the identity public key and the system public key, and is calculated by the relying party:

CPK′=IPK+SPK(point-add)

Second-order combination of the first-order combined key and the updating-key

The user self-defines a pair of updating-key UPK, usk. The updating key is kept by the user and is kept until next updating.

The second-order combined private key csk″ is a combination of the first-order combined private key csk′ and the updating private key usk, and is calculated by the signer:

csk″=(csk′+usk)mod n

The accompanying public key APK is combined by the system public key SPK and the updating public key UPK, and is calculated by the signer to provide to the verifier:

APK=SPK+UPK(point-add)

4. Digital Signature

The digital signature uses the second-order combination as an example:

The signing procedure:

If: Alice has a first-order combined private key csk′, an updating private key usk, and a system public key SPK,

Alice calculates the second-order combined private key:

csk″=(csk′+usk)mod n;

Alice calculates the accompanying public key: APK=IPK+SPK;

Then the signature of Alice is: SIG_{csk″}(TAG)=sign; (sign, APK) is provided to the verifier.

Wherein, the international standard of TAG is the identity domain, time domain, and string.

Verification Procedure:

If: The verifier has a public key combining matrix and receives the signature code (sign, APK)

The verifier calculates through mapping of Alice's identity and public key combining matrix: σ(ID)→IPK

The second-order combined public key of Alice is CPK″=IPK+APK

The verifier verifies: SIG⁻¹_{CPK″}(TAG)=sign′

5. Key-Exchange

Key-exchange uses the first-order combination as an example:

1) Calculation of the other party's public key

In Hash (ID)=YS, w₃₃-w₃₅ indicate the system key coordinates.

The sender combines the other entity B's identity public key and system public key into a first-order combined public key:

It is calculated by the relying party: CPK′_{B}=IPK_{B}+SPK_{B}

2) Encryption and Decryption Procedure

Assuming Alice encrypts for Bob, and Bob decrypts:

1. Selecting a random number r, and calculating: r(CPK′_{B}), sending to B;
calculating: rG as key k;
encrypting: Eₖ(data)=code;

Bob: using his own private key to calculate: csk⁻¹r cskG=rG=k
decrypting: Dₖ(code)=tada;

5. Security

In CPK system, identity-key always exists in a form of combination of random private key or system private key. For example:

csk′=isk+ssk;

This equals to encryption of the identity private key under the system private key.

csk′=Eᵣₛₖ(isk)

The random private key is a relative infinite random number sequence, and the encryption effects correspond to one encryption per time: on the condition that no collision threat will be caused to the system.

The compound type combined public key system is a public key system combined by identity-key and random-key. The combining matrix of identity is defined by KMC, used as a trust root to provide integrity proof of the identity and key. The system-key protects the identity private key, and the updating-key facilitates key updating. CPK adopts real-name registration system. No matter whether it is an identity for digital signature or an identity for key exchange, real-name is used.

(II) Comparison of Various Public Key System Functions

1. Requirements to the Public Key System

Digital signature is the core technology of authentication system. Any authentication system is composed of prover and verifier. In general, proof is provided by way of signing, and verification is implemented by way of de-signing. When digital signature is used for identity (identification) authentication, no matter whether it is proof or verification, the following issues need to be considered:

1) Scalability of digital signature: the signature space shall correspond to the identity space. If the identity is a bank account number, and the account number is 22 decimal digits in length, then the identity space is 10²², and signatures need to be provided to all of the identities.

2) Length of the digital signature: the length of the signature code cannot be too long, and the shorter the better. For example, in tag authentication, the tag itself only is several bytes to ten plus bytes in length, while the signature is over a hundred bytes to hundreds of bytes in length. Logically, it is likely that “spending 10 yuan (dollars) to guard 5 yuan (dollars)” would happen. Thus, the application will be greatly limited.

3) Immediacy of verification: once receiving the proof, verification can be conducted on-spot, so that waiting can be avoided.

4) Quickness of verification: verification operation shall be fast, to avoid that verification becomes the system bottleneck.

The requirement of key exchange is immediacy. That is, it is done by once, with the fewer links the better.

2. Comparison of Several Public Key Systems

Currently, the digital signature systems that have attracted attention here include: IES of Shamir (the article was named IBC, but Shamir only achieved identity-based signature, and thus called IES), Simplified CPK, Combined CPK, third-party based PKI, identity-based RSA, etc. A brief comparison will be made to the five signature systems as below.

1) IBS Signature Mechanism

Assuming: private-key: g; p, q; public-key: ID=g^{e}, n=p*q, parameter T={e}

signature: SIG_{g}(TAG)=sign, n TAG=time domain;

selecting a random number r, and calculating t=r^{e} mod n

calculating the signature code: s=g r^{f(t,m)} mod n

signature code is: sign=(s,t)

the length of the signature: s, t, n=3n.

verification: SIG⁻¹_{ID} (TAG)=sign′

calculating (s^{e}=ID t^{f(t,m)} mod n, (∵ s^{e}=g^{e} r^{ef(t,m)} mod n, s=g r^{f(t,m)} mod n)

verification operation: single verification calculation.

2) First-Order Compound CPK Signature Mechanism

Assuming: private-key: isk; public-key: Hash (ID)→IPK;

signature: SIGᵢₛₖ(TAG)=sign=(s,r) TAG=time domain;

length of the signature: sign=(s, r)=2n.

note: r can take half, and the signature length is 1.5n.

verification: calculating Hash (ID)→IPK

SIG⁻¹_{IPK} (TAG)=sign′,

verification operation: single verification calculation+(Hash (ID)→IPK).

3) Second-Order Compound CPK Signature Mechanism

Assuming: private-key: csk=isk+ssk+usk; public-key: CPK=IPK+SPK+UPK

signature: calculating the accompanying public-key APK=SPK+UPK;

SIG_{csk}(TAG)=sign=(s,r), APK; TAG=time domain;

length of the signature, (s,r)=2n, APK=2n, total 4n.

note: in (APK=(x, y)), only sending symbols of x and y, and r only taking half, then,

the signature length can be shortened to 2.5n.

verification: calculating Hash (ID)→IPK; CPK=IPK+APK+UPK

calculating: SIG⁻¹_{CPK}(TAG)=sign′=(s, r)

verification operation: single signature+(Hash(ID)→IPK)+(IPK+APK+UPK).

note: when the random public-key only selects x, calculation of square root of y is increased.

4) Third-Party Based PKI Signature Mechanism

Assuming: Alice's private-key is a, public-key is A, public-key certificate is

signature: SIGₐ (ID+TAG)=sign, CA certificate,

length of the signature, signature length+CA certificate.

verification: 1) certificate verification;
2) SIG⁻¹_{A} (TAG)=sign′

verification operation: 1) certificate verification (multiple verification);

2) Signature Verification

5) Dentity-Based RSA Signature Mechanism

Assuming: public-key: Hash(ID)→e, n; private-key d*e=1 mod (p−1)(q−1), p,q

signature: SIG_{d}(TAG)=sign, n;

length of the signature, mod n, signature code sign equal to 2n.

verification: calculating Hash(ID)→e

verification SIG⁻¹ₑ(sign)=TAG′

verification operation: single verification.

6) Individual Mechanism and Trust Root

In the authentication system, proof of the trust root is the most basic and essential proof. If there is no trust root or authenticity of the trust root cannot be proved, the whole authentication system cannot be established, or proof lacks of basis.

Under the condition that signature private-keys are uniformly defined by the key management center (KMC), the trust root is the KMC. This is called centralized management, and authenticity proof is very simple and clear.

In order to provide privacy to individuals, a system that private keys are defined by individuals is generated. This is called distributed management. Under distributed management, proof of trust root becomes a new problem.

For instance, PKI as a third-party proof system has strict authentication procedure. However, in order to adapt for on-spot verification, the original proof logic has been changed. The certificate is no longer provided by LDAP that represents the third party. Rather, it is provided by the user himself. That is, the third party proof mechanism is changed to self-proof mechanism. This causes a series of complex logical issues. This system is widely used in current seal and bill system in China and in the international trusted computing standard TPM, and is worth to conduct in-depth study. Proof logic can be established only if authenticity of the trust root can at least be proved (the trust root is not replaced or forged), otherwise the proof logic cannot be established. This is a new issue raised when adopting a system that the key is defined by individual.

7) Comparison of Functions of Various Systems

Comparison is made on the aspects such as signature length, amount of verification computation, private key definition system and immediacy of key exchange:

| | | times of | definition of |
|---|---|---|---|
| Public-key system | Signature length | verification | private key |
| IBS system | 3n (n = 128B) | single verification | System |
| First-order | 1.5n (n = 20B) | single verification | System |
| combined CPK | | | |
| Second-order | 2.5n (n = 20B) | single verification | individual |
| combined CPK | | | |
| Third party based | n + certificate | Multiple | individual |
| PKI | (n = 128B) | verification | |
| Identity-based RSA | 2n (n = 128B) | single verification | individual |

(III) Effects of Compound Type Combined Public Key Authentication System

The compound type combined public key provides a public key generation system combined by centralized key management and self-defined key generation. Self-definition of key by individuals is allowed under the centralized key management mode, to ensure privacy, so that anybody (except the entity) including the management center cannot forge signature. This provides great advantages.

The compound type combined public key can construct a digital signature system, and can also be used for key exchange system. When used for key exchange, if the exchange key is still defined by the individual, then support from directory LDAP is needed, same as PKI. Personalized key exchange mechanism squeezes out administrative intervention, which may not be desirable to national security, and may not be desirable for wide range intercommunication. Thus, CPK key exchange still adopts a mechanism of uniformly defined by the system, and does not adopt self-definition mechanism.

The entity identity is registered and approved by the management center, and the identity-based system facilitates to carry out real-name system in the cyber-world, which is helpful to construct a cyber-world with order. The compound type combined public key keeps the original features of the combined public key, and adds new features:

1. The first-order combined private key in the compound type combined public key system is a combination of the system private key and the identity private key:

csk′=isk+ssk;

Essentially it is an encryption of the random number to the identity private key:

csk=Eₛₛₖ(isk)

The system private key ssk, upon generating the combined private key csk and the system public key SPK, will be automatically destroyed, and only exists in the form of sum in the combined private key. This greatly improves the security of the private key combining matrix. Thus, the size of the combining matrix can be very small, for example, a matrix of 32×32 is enough.

2. The compound type combined public key system allows individual to change the key at any time under centralized management mode, and does not need support of certificate revocation library CRL, so that there is no need of system maintenance. Since the accompanying public key (APK) of combination of the updating public key (UPK) and the system public key (SPK), as a portion of the signature, is always with the signature code, on-spot verification will not be affected whenever signing.

Thus, it can be seen that the compound type combined public key system is concise and compact, and provides great convenience to demonstration and evaluation of operation safety, so that it is very easy to find application in various systems.

II. System Structure

Basis architecture of CPK system is described in the Applicant's prior application no. 20061007609.X entitled “CPK trusted authentication system”, which is incorporated herein by reference in its entirety.

CPK trusted authentication system is an authentication system implemented with chip, in which the chip includes dedicated COS, CPK system, ID certificate, signature protocol and key exchange protocol, encryption algorithm and HASH function, etc. Depending on different encapsulation and interface, the chip can be divided into smart card, USB Key, Flash memory card, mobile SIM card and so on. The public key matrix is written into the chip based on needs, and the public key of the other party can be calculated on the spot. A chip can not only undertake cryptograph function, signature verification function, and database key storage function, but also has e-card function in various identity domains and security domains, which can conveniently construct a trusted authentication system.

In CPK trusted authentication system, most functions are implemented in the chip, to ensure security of the authentication procedure, and to realize chip solution of the authentication system, so as to provide the most convenient authentication service. The chip includes:

dedicated COS supporting the CPK trusted authentication system; relevant algorithm supporting the CPK operation; ID certificate, including the parameter and key of role dividing; CPK digital signature protocol, CPK key exchange protocol; classification encryption protocol, password changing protocol, running format protocol; private key protection technical measure, etc.

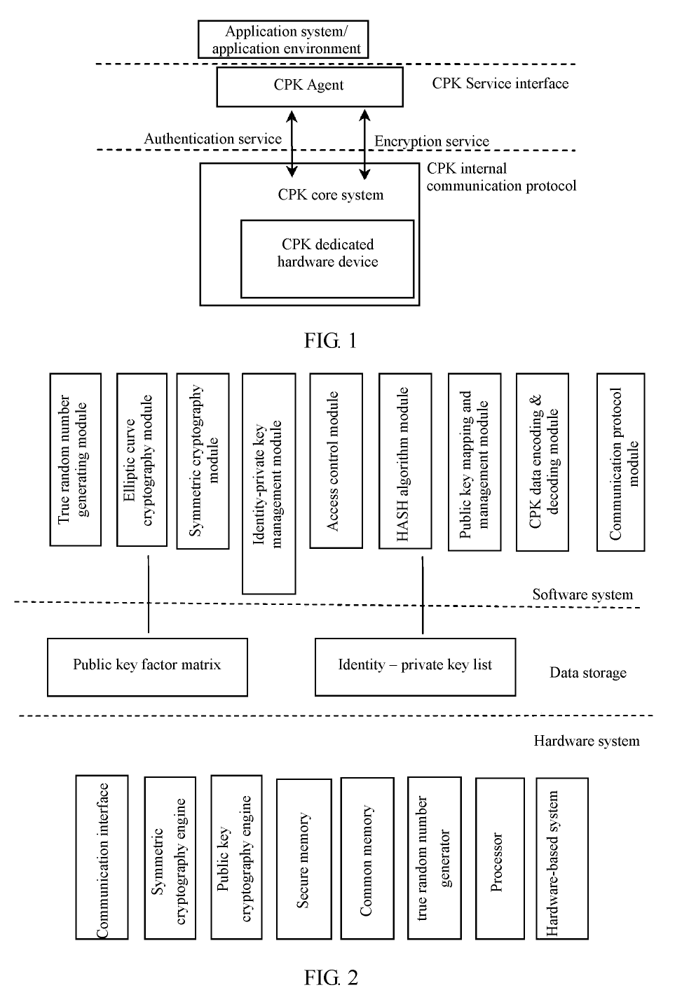

FIG. 1 shows a basic construction of CPK system according to the present invention. The system physically at least includes a device used as the CPK dedicated hardware device, which can be composed of various hardware devices and relevant software including computer and network, depending on the particular implementation and environment.

Attention is directed to FIG. 1. The system logically includes two main sections, CPK core system and CPK agent. The CPK core system uses as an independent logic unit to implement CPK system, providing authentication and encryption functions through the hardware interface and software interface. The CPK Agent is typically embedded in the application system or application environment, to provide CPK authentication and encryption services. The service interface can have various forms, including but not limited to, e.g., API, middleware, system service, network service, etc. CPK Agent itself cannot implement the CPK basic functions. Rather, it invokes the functions of the CPK core system through a specific communication protocol with the CPK core system, and provides the application environment with the services. The CPK Agent will also encapsulate or enhance the functions of the core system to some extent, so as to satisfy the needs of the application system.

FIG. 2 shows a detailed construction of a CPK system according to the present invention. The CPK Built-in dedicated hardware system is comprised of software in combination with hardware, and the software system operates on the dedicated hardware device and universal network and computer platform.

Attention is directed to FIG. 2. The CPK Built-in chip includes hardware system, software system (i.e., CPKCOS) and internal relevant data. The hardware system is comprised of a plurality of IP cores with different functions, providing modules such as basic processor, memory, cryptography engine, and random number generator, etc. The software system is stored in the Flash memory inside the chip or is directly burn into the ROM memory. The software system invokes and packages the basic functions provided by corresponding hardware modules, to implement various algorithms and protocols of CPK. A portion of the modules in the software system also reads/writes some data storage related to the CPK system, including public key factor matrix and identity-private key list, etc.

Depending on the particular forms, the dedicated hardware device of the system has all of or some of the following system components:

1) Processor, for processing various data, so as to control and manage the whole system.

2) Secure memory, the data of which can only be accessed by specific instructions of the processor or specialized peripheral device. The attacker cannot bypass the interfaces to access data in the memory, and cannot access the data therein by logical or physical means such as chip attack.

Common memory, for storing other data.

4) Public key cryptography engine, providing instructions for public key operation, and supporting elliptic curve cryptography operation.

5) Symmetric cryptography engine, providing operation instructions such as symmetric encryption, hash algorithm.

6) True random number generator, for generating true random numbers.

7) System protection device, including protective devices for safe encapsulation of chip and resistant to chip attack.

Communication interface, including USB controller, serial interface or smart card interface, for communicating with peripheral device.

The software of the system includes the followings:

1) Identity-private key management module, for storing, managing, processing, protecting the private key and identity data. All the operations to the private key are done by this module. This module invokes the elliptic curve cryptography module to implement elliptic curve signature and decryption operation of the elliptic curve public key encryption.

2) Public key factor matrix management module, for mapping the identity to index of the public key factor matrix through mapping algorithm, and calculating corresponding public key through the CPK system and the public key factor matrix.

3) Access control module, through password and cryptography function protection system to ensure that only the users having the password can access the system.

4) Elliptic curve cryptography module, for implementing elliptic curve signing, verification and key exchange.

5) Symmetric cryptography module, providing symmetric encryption, hash algorithm, MAC algorithm, etc.

6) HASH algorithm module, for conducting operation to the data based on HASH function.

7) True random number generator, generating true random numbers.

8) CPK data format encoding/decoding module, for encoding and decoding data in CPK format.

9) Communication protocol module, for achieving communication protocol with the CPK Agent, to provide service to the CPK Agent in a manner of request-response instruction.

According to the present invention, data in the system includes public key factor matrix, current user's identity and corresponding private key. The data is stored in the form of ID certificate.

If the hardware device provides corresponding implementation, then the elliptic curve cryptography module, symmetric cryptography module and true random number generator would directly invoke the hardware functions. Otherwise, it would be implemented through software.

III. ID Certificate

The most important element in the ID certificate is user identity and user's private key. The user identity is the only logic representation of the entity identification. In CPK system, each identity can be mapped to a unique public key. The ID certificate provides the user's private key to the user, and publishes the public key matrix containing all of the relying parties' public keys in the form of files.

1) Applying for ID Certificate

An end entity has to make registration before joining the CPK system. The end entity submits an application to the local registration management center RMC. The management center generates an ID certificate and distributes to the end entity. CPK system adopts real-name registration system. Taking Minsheng Bank's bill & seal system as an example, the application form is as follows:

2) Definition of the ID Certificate

The ID certificate contains two parts: a certificate proper and a variable. The certificate proper defines the user's properties and is consistent. The variable defines the actual contents of the ID certificate, such as entity identity, private key of the identity, etc.

The ID Certificate Proper

| | | |
|---|---|---|
| 1 | Card name | Minsheng Bank bill and seal system card |
| 2 | Identity name | e.g., bank account number |
| 3 | Valid term | 2007-2010 |
| 4 | issuing unit | e.g., Minsheng Bank key management center |
| 5 | Signature of the | SIG_{Minsheng Bank key management center} (card data) |
| | issuing unit | |

ID Certificate Variable

| | | |
|---|---|---|
| 0 | Z1: verification parameter | Z1 = E_{PWD}(R1); R1 is a random |
| | | number to protect the private key |
| 1 | Z2: verification parameter | Z2 = E_{R1}(R1)⊕R1; for legitimacy |
| | | verification. |

| | | |
|---|---|---|
| 0 | Digital signature first-order combined private key | E_{R1}(csk′) |
| 1 | Accompanying public key | APK |

| | | |
|---|---|---|
| 0 | Issuing unit | Real name |
| 1 | Signature of issuing unit | SIG_{issuing unit} (MAC of the ID certificate) |

Generation of ID Certificate

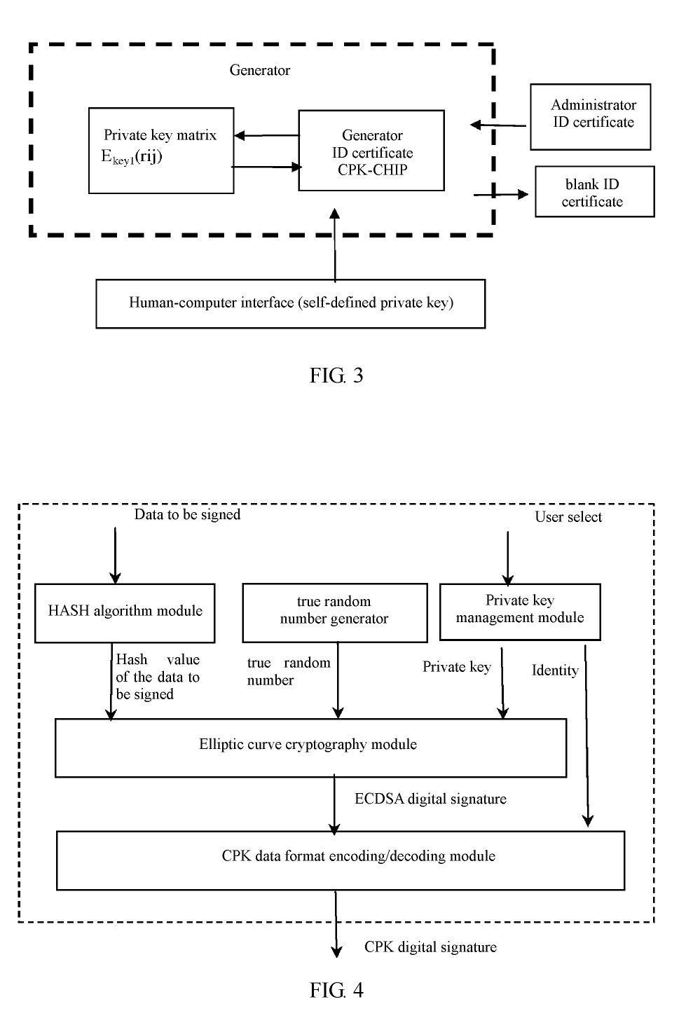

Referring to FIG. 3, it shows a schematic diagram of generating a ID certificate.

The main components of generating the private key include:

Generator: configuring the ID certificate;

Blank ID certificate: the object for writing; having a unique serial number which is defined in the chip and is printed on the surface of the certificate to facilitate management.

Administrator: configuring the ID certificate;

The procedure of generating the private key includes:

Administrator: inserting the ID certificate;

Inputting the administrator's password; PWD1 opening the ID certificate (U-KTY), and checking the legitimacy of the password;

Judging whether it is the administrator's certificate, if no, then quit; if yes, go to the next step;

Inputting the password of the generator: PWD2 opening the generator and checking the legitimacy of the password;

If legal, then allowing the administrator to operate.

Generator: composed of private key matrix and CPK-chip, in which the CPK-chip has the function of user ID certificate, for receiving the certificate element of the human-computer interface;

Writing the relevant certificate elements into the blank ID certificate.

ID certificate: having all the functions except for the private key.

IV. Workflow

1. Hardware Workflow:

FIG. 4 shows the workflow of the CPK digital signature. CPK Built-in based digital signature procedure is as follows:

1) The user chooses an identity in the identity list of CPK Built-in for digital signature.

2) The user inputs the data to be signed into the CPK Built-in chip.

3) The Hash function module in the CPK Built-in chip calculates the hashed value of the data to be signed.

4) The random number generator in the CPK Built-in chip generates random number for signature.

5) The private key management module in the CPK Built-in chip reads the corresponding private key with the user identity.

6) The elliptic curve cryptography module generates ECDSA digital signature through the hashed value, random number and private key.

7) The data encoding module uniformly encodes the ECDSA digital signature value and the identity for signature into CPK formatted digital signature data packet, and sends out of the CPK Built-in chip to the user.

Referring to FIG. 4, the signature verification procedure based on CPK Built-in digital signature is as follows:

1) CPK Built-in chip reads in the CPK digital signature and the signed source data from exterior.

2) Hash function module calculates the hashed value of the signed data.

3) CPK data format encoding/decoding module obtains the identity of the signer and ECDSA digital signature data from CPK digital signature.

4) Identity-public key mapping algorithm module maps the identity of the signer to the public key for the signer to sign.

5) The elliptic curve cryptography module verifies whether the signature is valid through the hashed value, ECDSA digital signature and the public key of the signer, and returns the results to the user.

Software Workflow

Based on the operation procedure, first the signer conducts the signing operation, and then the relying party/verifier verifies the signature. Taking the signature procedure of Alice as an example:

2.1 Signature Procedure of Alice

The signer satisfies:

1. Identity of the signer: Alice

2. ID certificate of the signer:

In the certificate, the combined private key of Alice

csk=(identity private key m+random private key a);

random public key APK=aG;

Signing procedure of the signer:

Alice signs to TAG; in which TAG is a tag, including identity domain and time domain.

SIG_{csk}(TAG)=sign;

Wherein, two-factor private key csk=(m+a) mod n

m is generated from mapping of the identity Alice with the private key combining matrix, and thus m can represent Alice.

n is defined by the parameter T=(a, b, p, n) of the elliptic curve E: Y2=x3+ax+b.

2. The signature code sign and the random public key APK=aG are sent to the relying party, providing the authenticity proof of Alice to TAG

2.2 Verification Procedure of the Relying Party:

The relying party satisfies:

1. Having digital signature combining matrix (R_{i,j}); and everyone having this matrix;

2. Knowing the other party's identity Alice, signature code sign and random public key APK=aG sent by the other party;

Signature verification procedure of the relying party:

External procedure: SIG⁻¹_{Alice}(TAG)=sign;

Internal procedure: SIG⁻¹_{CPK}(TAG)=sign′;

Wherein, the combined public key is CPK=mG+aG;

mG is the identity public key IPK, is calculated from mapping the identity Alice with the public key matrix (R_{i,j}), and can be calculated by every relying party; while the self-defined public key aG is sent with signature code by the other party, and thus can calculate: CPK=IPK+APK.

Calculating SIG⁻¹_{CPK}(TAG)=sign′, if sign′=sign,
then it is believed that Alice and TAG is true, otherwise Alice and TAG is not true.

The above describes the identity authentication procedure in connection with the embodiments. During communication, as long as the communication tag of the other party has been received, the legitimacy of this communication body can be determined. If illegitimate, this communication will be denied. Thus, the communication will be cut before the communication event will happen, so as to ensure trust connection. Similarly, in the software tag authentication, legitimacy of the software will be judged before loading the software, to avoid loading of illegal software, i.e., allowing invasion but preventing it from operating, to ensure the trustworthy of the computing environment.

IV. Application Fields

Authentication includes identity authentication, data authentication, and behavior authentication, etc. The entity identity can be divided into user identity, communication tag identity, software tag identity, address identity, number identity, account number identity, seal identity, etc. As signing entity is different, authentication of the entity identity can be classified, such as nation-level authentication, industry-level authentication, enterprise-level authentication, and entity-level authentication. All of the private keys are uniformly managed by the sole authentication center. The ID certificate is an identity signature card, having the function of signing with the defined identity. The verification machine is a device that verifies any signatures.

### Example 1

### Entity Identity Authentication

In a transaction, business relationship between the entities came first, which involves authentication of the entity identity and authentication of data. If data contains seal, such as the seal of a corporate, an account number, a bank, and special seal for financial affairs, etc., then authentication the seal identity will further be involved.

The initiator of the transaction is the prover, who shall provide proof of authenticity for the entity identity and for the data. Proof of authenticity for the entity is the signature of the entity's identity to the identity itself. Proof of authenticity for the data is the signature of the entity's identity to the data (entity level/user level). Proof of authenticity for the seal is the signature by the seal's identity to the seal itself (identity level). If privacy is desired, support by key exchange may be used, for example:

identity signature: SIG_{entity idnetity} (TAG);

data signature: SIG_{entity idnetity} (MAC);

seal signature: SIG_{seal idnetity} (TAG);

data encryption: E_{key exchange} (data).

In entity transactions, the e-Bank (ATM/POS) system is a business system using the account number as identity. The account number identity of the entity provides proof for the account number identity, and the bank can directly verify the account number identity. The bank only stores the public-key used for verification, so that any suspect of internal crime can be ruled out, and the entity's (depositor) benefits will not be affected if there is loss of any bank information. Also, proof of withdrawal of money with the account number can be obtained.

In entity transactions, authentication on electronic notes actually is authentication to various seal identities. One note may contain various seals, such as the seal of the organization, of the corporate, and of special usage, etc. Verification shall be conducted to each seal identity. CPK authentication is very easy, since the verifiers all have the public-key matrix (Ri,j), with which any identity can be verified on spot.

If privacy is desired during the transaction, key exchange and encryption function will be provided.

### Example 2

### E-Note Authentication

See the Applicant's prior application no. 200610081134.6 entitled “CPK-based e-note trusted authentication system and method”, which is incorporated herein by reference in its entirety.

In e-note, the relationship between proof and verification is as follows:

Three signatures are needed, for such as account number, name, and unit, e.g.:

sign1=SIG_{account number} (mac);
sign2=SIGₙₐₘₑ (mac);
sign3=SIGᵤₙᵢₜ (mac);

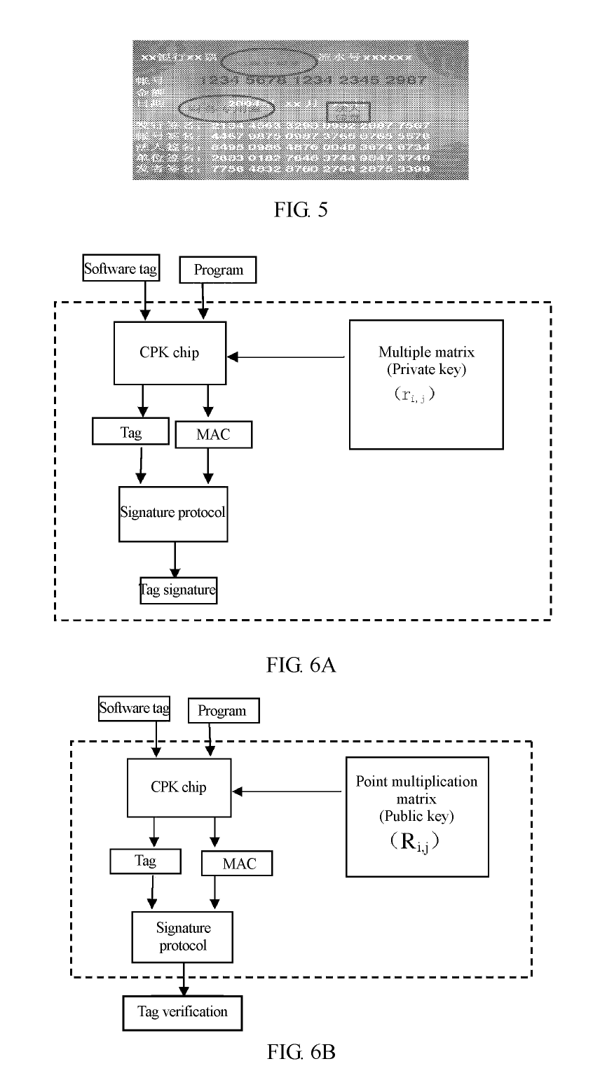

The note file and the signature field are prepared into one file, such as the note file as shown in FIG. 5.

The verification system in the bank server verifies each digital signature upon receiving the e-note.

The e-note along with the digital signature can be stored in the database in the form of electronic document, or can be printed out as hardcopy. Both have same effects as the true note.

### Example 3

### Software Tag Authentication

See the Applicant's prior application no. 200610081133.1 entitled “CPK-based trusted authentication system”, which is incorporated herein by reference in its entirety.

Transaction between users is carried out through the computer, and hence there is a demand for trusted computing. The trusted computing needs to solve three problems: 1. whether the program shall be loaded; 2. whether the program is loaded correctly; 3. whether the program is running as expected. As the first checkpoint for trusted computing, i.e., whether the program shall be loaded is very important. It can be solved using the identification technology of process identity. If the identity is illegitimate, loading is denied. Thus, the malicious software such as virus cannot take effect even if successfully invaded. The software tag authentication needs the coding signing technology to solve the problem.

For a banking system, if no software other than those approved by the bank is allowed to run in the system, the governor of the bank will be pleased.

Authentication of software identity made by nation-level organization is called first-level authentication, and that made by industry-level association is called second-level authentication. Identity of software is defined by the producer. Proof of authenticity of the software identity is provided by signature of the authenticating organization to the identity and data. For example:

SIG_{authentication organization} (TAG);
SIG_{authentication organization} (MAC);

The verification module can perform on-spot verification to any identity, and only allows software that has been authenticated to run in the system, so as to ensure trustworthy of the computing environment. The verification module only contains public variable such as the public-key matrix (R_{i,j}) and has no private variables. It can also be for general use.

FIGS. 6A and 6B respectively show the signature module and verification module according to the present invention.

Attention is first directed to FIG. 6A. It shows a schematic view of the signature module according to the present invention, wherein:

(I) The label is defined by the software company, e.g., the software package or program name is: label.

(II) Label signature module (LSM) is composed of CPK function module, signature protocol module, and multiple (private-key) matrix (r_{i,j}), with the functions that: as long as the label name of the program is input, the private key of the label can be generated, and the signature label (certificate) can be output. The multiple matrix in the label signature module is a secret variable, stored in the SAM card to be protected. The label signature module is configured in the sole label management organization.

Operation of the label signature module is in two steps as below:

Assuming: program label (name): label;

Program: procedure A;

Label signature module generates private key based on the program name label: SKlabel;

1st step, proof of the label, using the label private key to sign the label integrity code, e.g.:

Label integrity code: HASH (label)=MAC₁;

Signing to the integrity code: SIG_{SKlable}(MAC₁)=sign₁;

2^{nd} step, calculating the integrity code of the program, using the label private key to sign the integrity code, e.g.:

Label signature module calculates the integrity code of the program:

HASH (procedure A)=MAC₂;

Label signature module using the private key signature to make signature label:

SIG_{SKlabel} (MAC₂)=sign₂;

Label management organization issues the signature label sign₁ and sign₂ (certificate) to the software company; and the software company publishes the trademark (program name label), program (procedure A), and signature label (sign₁ and sign₂), or makes them commercially available.

Attention is directed to FIG. 6B. It shows a schematic view of the verification module (LVM) according to the present invention, wherein:

Each computer is configured with a label verification module. The label verification module is embedded with CPK function module, verification protocol module, and point multiplication (public key) matrix (R_{i,j}), Its function is that upon inputting any label, the public key of the label can be output. Thus, any signature label can be checked, and the legitimacy can be determined on spot.

The workflow of the verification module is shown in FIG. 6B. The verification module verifies the program in two steps. In first step, when loading every programs, sign₁ is first checked, to determine whether the program shall be downloaded. Sign₁ provides proof of authenticity of the label. If not true, the program will not be downloaded; if true, the program will be downloaded. When downloading the program, the label verification module conducts parallel computation on the integrity code MAC₂, and checks sign₂. The sign₂ provides integrity proof of the label and the program. If true, then executes; if not, then indicates that: xxx program is a no-signature label program, continue (y), terminate (n), skip (s).

Comparing with the trusted computing (trusted loading) module (TPM), the label verification of this embodiment is performed in two steps, and the key of determining true or false is in the first step.

### Example 4

### Electronic Tag Authentication

See the Applicant's prior application no. 200610065663.7 entitled “Anti-counterfeiting method and apparatus based on CPK electronic tag”, which is incorporated herein by reference in its entirety.

In logistic chain of the transactions, if counterfeits prevail, then there will be no trusted transaction. Thus, there is a need against forgeries. RFID provides an excellent basis for electronic counter-forgery. Physical RFID can prevent imitation, and logical identity authentication can prevent impersonation. Combination of the two can provide powerful counter-forgery function. Logistic identity authentication is essentially similar to software identity authentication, in which identity of the article is defined by the producer, and the first or second level authentication organization is responsible for signature to the identity of the article. SIG_{authentication organization} (identity of the article+serial number)=sign;

For implementation of counter-forgery based on identity authentication, a verification machine can be used for millions of different article identities. The verification function can be embedded in cell phones, so that the public can authenticate the RFID tag on spot. This effectively inhibits widespread of counterfeited products.

The verification machine can verify any ID tag signature. The verification is non-contact, and verification results can be obtained on spot.

RFID technology solves the issue of automatic collection of data and physical duplication of tag, and CPK technology solves the issue of authenticity proof of data in RFID and logic imitation. Combination of RFID and CPK embeds a unique and unchangeable ID number, article identity number for each RFID, so that the code can only be verified by the verification device and cannot be duplicated and counterfeited.

One RFID card has one unique ID number, and has an ID identity defined by respective companies. The ID identity typically is composed of company name, article name, serial number, time stamp, etc. In identity-based scale authentication system, it is very easy to make the verification machine to be universal and common. Thus, this technology can be widely used in anti-forgery of variable articles (container, license plate, certificate, trademark), bank note, ticket, entrance ticket, etc., and a universal verification machine can be used to verify.

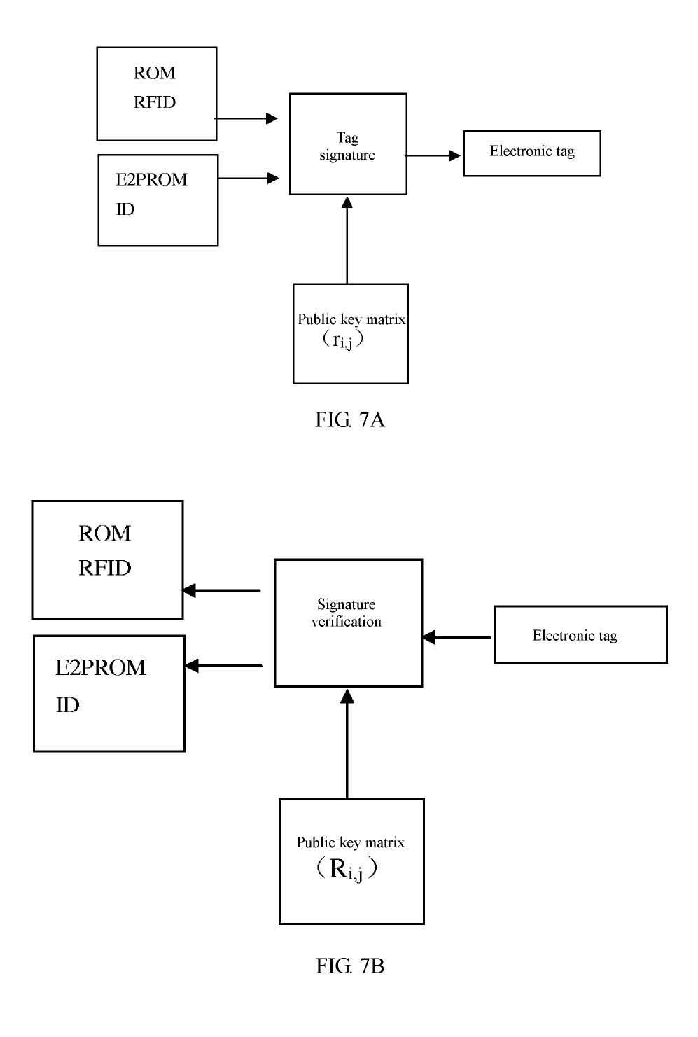

FIG. 7A shows the flowchart of generating a CPK electronic tag according to the present invention.

The certificate Authority (CA) has private key matrix (r_{i,j}) and mapping algorithm, in which the private key matrix (r_{i,j}) is protected by SAM card. CA uses the private key matrix (r_{i,j}) and mapping algorithm to implement digital signature to article identity defined by the producer: SIG_{ID} (identity), and lock-writes into the memory area (E²PROM) embedded in the RFID tag, to complete an electronic tag of one ID identity.

Incorporating the electronic tag and the physical property of the article realizes integration of the electronic tag and article. The producer is responsible for bonding the electronic tag and the anti-forgery object, to ensure that the tag and the article are inseparable. Separation will cause damage to the electronic tag. The tag and article, upon being bonded, can enter into circulation field.

FIG. 7B shows a flowchart of verifying the CPK electronic tag according to the present invention. Each verification machine has the CPK public key matrix (R_{i,j}) and the mapping algorithm, and can calculate the public key corresponding to any identity. Thus, verification can be conducted to the electronic tag of any identity. The verification machine reads out the signature data in E²PROM on RFID, verifies with the public key of the ID identity, and the verification result is shown on the screen. Since the amount of data of the public key matrix (R_{i,j}) in the verification machine is very small, the verification function can be embedded in a handheld device such as cell phone, to make the device to have the verification function, so that everyone can have the verification function.

Since the electronic tag and article realize integrity, authenticity of the article can be proved.

### Example 5

### Communication Label Authentication

Transactions between network users are carried out through communication system (network). Hence, there is a demand for trusted connecting. Generally speaking, business between users of the business layer and business between equipment of the communication layers belong to different layers. The communication layer is only responsible for transmission of data. Thus, with respect to proof system, it is nothing to do with user business.

The first problem encountered during communication is whether the data is to be received or not, and the second problem is whether the data is received correctly. As the first checkpoint of trusted communication, i.e., judging whether the data is to be received or not is very important. At this moment data has not been received, so that data integrity signature cannot be used to determine authenticity. Rather, only proof on authenticity of the identity can be used. If the identity is illegitimate, then receipt of data is denied, so as to effectively prevent illegal access. If privacy is desired in communication, then key exchange and data encryption will be provided.

As to the communicating parties, the initiator is always the prover, and the receiver is always the verifier. The initiator sends proof of the communication identity and proof of data integrity. Proof of the communication identity is the signature of the communication identity to the communication identity. Proof of data is the signature of the communication identity to the data, for example:

two-factor private key signature of the initiator communication identity:

SIG_{csk}(TAG)=sign, APK.

The initiator sends sign and the random factor public key APK to the receiver before formal data communication. The receiver, upon receiving the header, directly conducts verification, and checks whether the sender is legal to send. If yes, then continue communication and transmit data; if no, then cut off this communication, to ensure trusted connecting.

verification procedure of the receiver follows:

the sender identity and the public key matrix are used to calculate the sender's identity factor public key IPK, and then the random factor public key sent by the sender is used to calculate the two-factor public key CPK of the sender. For example:

CPK=IPK+APK;

SIG⁻¹_{CPK}(TAG)=sign′

if sign=sign′, then passes verification.

With the trusted connection (trusted access) technology of communication identity authentication, the basic protocol of communication will be changed. For instance, the previous protocols such as SSL, WLAN require more than 10 steps of interaction to complete safe connection. With the identity authentication technology, only 1-2 steps are required to accomplish trusted connection (trusted access). In addition, all the authentication tasks are distributed to respective user terminals. This greatly alleviates the burden of the exchange equipment, so that balance of load can be achieved. This provides authentication communication by cell-phone with great convenience, and technically can realize all-the-way authentication and privacy.

### Example 6

### Network Order and Management

Currently, information security has entered into a new era of cyber security. The development focus is no longer how to passively protect the information system that is separated from the physical world, but to establish a trusted society that the information world and the physical world are integrated with each other and is based on active management. The nature of the trusted world (or harmonious society) is embodied in “order” and “management”, which will be the main task of the new generation information security.

Establishing order and implementing management in the cyber-world can only rely on identity authentication technology. The “identification card” system in the physical world provides precious experience for establishing a trusted cyber-world. If in the internet, everyone has a unique provable identity, order on the net will not be difficult to establish. Once the order on net is established, any anonymous activities will be restricted.

Similar to the physical world, the cyber world is divided into a world of order and a world without order. Experience in the physical world and research on authentication theory show that establishing order in a disorder world can only be done from bottom to top. The order in the disorder world can only be guaranteed by the world with order, and cannot be guaranteed by the disorder world itself (not partial guarantee but overall guarantee). For example, in the physical world, bank notes and invoices are printed by the world with order, to be used by the world without order. In the cyber world, the entity identity shall also be under unified management and adopt real-name system. In that way, everyone will be responsible for his/her own behavior, so as to realize social management and self-discipline, which is the basis to construct a trusted and harmonious society.

The above description is only for the preferred embodiments, and is not intended to limit the invention. Apparently, peoples killed in the art can make various modifications and variations to the present invention without departing from the scope and spirit of the invention. Thus, if such modifications and variations fall into the scope of the appended claims or equivalent to those disclosed, they are intended to be included in the invention.

We claim:

1. A method of generating a compound type combined public key, including the following steps:
a) a key management center KMC generating an identity private-key isk based on a combining matrix and an entity identity;
b) the key management center KMC defining a system private-key ssk for each entity,
c) the key management center KMC combining the identity private-key isk and the system private-key ssk to generate a first-order combined private-key csk′;
d) the key management center KMC calculating a system public key SPK corresponding to the system private key ssk;
e) the key management center KMC writing the first-order combined private-key csk′ into a ID certificate;
f) a relying party combining an identity public key IPK and the system public key SPK to generate a first-order combined public key CPK';
g) a user self-defining an updating private key usk and an updating public key UPK;
h) the user combining the first-order combined private key csk′ and the updating private key usk to generate a second-order combined private key csk″;
i) the user combining the system public key SPK and the updating public key UPK to generate an accompanying public key APK; and
j) the user combining the identity public key IPK and the accompanying public key APK to generate a second-order combined public key CPK″.

2. The method of claim 1, wherein:
the first-order combined public key CPK′=identity public key IPK+system public key SPK.

3. The method of claim 1 or claim 2, wherein step a) includes:
the key management center KMC generating the identity private key isk of an entity based on the entity identity and a private key combining matrix.

4. The method of claim 1 or claim 2, wherein step e) further includes:
when the private key of each entity needs to be changed, each entity self-defines or changes the updating private key usk.

5. The method of claim 1 or claim 2, wherein step c) includes:
writing the first-order combined private key csk′ into the ID certificate and distributing to the user.

6. The method of claim 1 or claim 2, wherein when signing, the second-order combined private key csk″ is used to sign, and the accompanying public key APK is sent to the relying party as a portion of a signature code.

7. The method of claim 6, wherein the signature code is:
SIG_{csk″}(TAG)=sign, APK,
wherein SIG is a signature protocol, csk″ is the second-order combined private key used for signature, TAG is entity identity domain, time domain and specified string defined by an international standard, sign is the signature code, and APK is the accompanying public key.

8. The method of claim 6, wherein when verifying the signature, the relying party uses a combining public key matrix to calculate the identity public key IPK, and then uses the accompanying public key APK sent by a signer to calculate the second-order combined public key CPK″ of the other party, so as to verify authenticity of the signature.

9. The method of claim 8, wherein the verification code is:
SIG⁻¹_{CPK″}(TAG)=sign′,
wherein SIG⁻¹ is a verification protocol, CPK″ is a second-order combined public key, TAG is an entity identity domain, time domain and specified string defined by an international standard, and sign′ is a verification code.

10. The method of claim 1 or claim 2, wherein the combined public key is combined by the identity key, the system key and the updating key.

11. The method of claim 1 or claim 2, wherein:
second-order combined public key CPK″=identity public key IPK+accompanying public key APK.

12. The method of claim 10, wherein the identity key is defined by the combining matrix.

13. The method of claim 10, wherein the updating key is self-defined or changed by the user.

14. The method of claim 10, wherein the identity key is generated on the basis of a combined public key CPK system.

15. The method of claim 10, wherein randomly defined key can be generated by a random number generator.

16. The method of claim 10, wherein the combining matrix for generating the identity key is defined by the key management center.

17. The method of claim 16, wherein definition of the combining matrix determines a nature of centralized management of the system.

18. The method of claim 17, wherein the combining matrix implements mapping from an identity to a key variable, to become a “trust root” of the system.

19. The method of claim 16, wherein the key management center publishes the public key combining matrix as a trust root, for each entity to calculate the identity public key.
